(19) United States
(12) Patent Application Publication
(10) Pub. No.: US 2007/0290151 A1
(43) Pub. Date: Dec. 20, 2007

(54) Valve

(76) Inventor: Matthew Thomas Muller, Peoria, IL (US)

Correspondence Address: CATERPILLAR/FINNEGAN, HENDERSON, L.L.P., 901 New York Avenue, NW, WASHINGTON, DC, 20001-4413, US

(21) Appl. No.: 11/453,904

(22) Filed: Jun. 16, 2006

(51) Int. Cl. F16K 31/12

(52) U.S. Cl. 251/26

(57) ABSTRACT

A valve includes a housing with a first port and a second port. The valve may also include a first valve member operable to meter fluid flow between the first port and the second port. Additionally, the valve may include valve controls operable to control the position of the first valve member at least partially with fluid supplied to a control chamber. The valve controls may include one or more additional valve members operable to meter fluid flow to the control chamber and also fluid flow from the control chamber. The one or more additional valve members may include a pilot poppet operable to meter fluid flow from the control chamber. The valve controls may be operable to control the position of at least one of the one or more additional valve members at least partially as a function of the position of the first valve member.

### TECHNICAL FIELD

The present disclosure relates to valves and, more particularly, to fluid-controlled valves.

### BACKGROUND

Many valves include a valve member for metering fluid flow through the valve and valve controls for controlling the position of the valve member. Some valve controls use fluid to control the position of a valve member. For example, some valve controls supply fluid to a control chamber where the fluid exerts force on the valve member to counteract other forces on the valve member. Such valve controls often control the pressure of fluid in the control chamber by metering drainage of the fluid from the control chamber. The valve controls may suppress drainage of fluid from the control chamber to create high fluid pressure in the control chamber so that the fluid drives the valve member in one direction. Conversely, the valve controls may allow other forces to drive the valve member in an opposite direction by increasing drainage of fluid from the control chamber to decrease the pressure of the fluid in the control chamber.

Unfortunately, many such valve controls do not include provisions for metering supply of fluid to the control chamber. In some circumstances, such valve controls may be capable of causing the valve member to move rapidly in one direction, but incapable of causing the valve to move rapidly in the opposite direction. If such valve controls are configured to supply fluid to the control chamber at a relatively rapid rate, the valve controls may be able to cause the fluid in the control chamber to rapidly drive the valve member by suppressing drainage from the control chamber. However, such valve controls may not be able to drain fluid from the control chamber at a rate sufficiently greater than the supply rate to allow other forces to drive the valve member in the opposite direction against the fluid in the control chamber. Conversely, valve controls configured to supply fluid to the control chamber at a relatively low rate may be able to drive the valve member only at a low rate with the fluid supplied to the control chamber.

U.S. Pat. No. 5,421,545 to Schexnayder (“the '545 patent”) shows a fluid-controlled valve with provisions for metering fluid flow into a control chamber thereof, in addition to metering fluid flow out of the control chamber. The valve shown in the '545 patent includes a body with a first port and a second port connected by passages extending through the body. The valve also includes a poppet valve element for metering fluid flow between the ports. Additionally, the valve includes a control chamber disposed adjacent the poppet valve element. The valve of the '545 patent is configured such that fluid pressure in the control chamber urges the poppet valve element toward a closed position against fluid pressure in the first port. The valve of the '545 patent also includes provisions for supplying fluid from the first port to the control chamber and provisions for draining fluid from the control chamber to the second port. These provisions include a spool that meters both fluid flow from the first port to the control chamber and fluid flow from the control chamber to the second port.

Although the valve of the '545 patent includes a spool that meters fluid flow into the control chamber and fluid flow out of the control chamber, certain disadvantages persist. For example, the spool may leak, which may compromise performance when drainage from the control chamber is undesirable. Additionally, because the valve is only able to supply fluid to the control chamber from the first port, the valve may be able to control the position of the poppet valve element only when the pressure in the first port is higher than the pressure in the second port.

The valve of the present disclosure solves one or more of the problems set forth above.

### SUMMARY OF THE INVENTION

One disclosed embodiment relates to a valve having a housing with a first port and a second port. The valve may also include a first valve member operable to meter fluid flow between the first port and the second port. Additionally, the valve may include valve controls operable to control the position of the first valve member at least partially with fluid supplied to a control chamber. The valve controls may include one or more additional valve members operable to meter fluid flow to the control chamber and also fluid flow from the control chamber. The one or more additional valve members may include a pilot poppet operable to meter fluid flow from the control chamber. The valve controls may be operable to control the position of at least one of the one or more additional valve members at least partially as a function of the position of the first valve member.

Another embodiment relates to a method of operating a valve having a housing with a first port and a second port. The method may include metering fluid flow between the first port and the second port at least partially by controlling the position of a first valve member. Controlling the position of the first valve member may include metering fluid flow to a control chamber and metering fluid flow from the control chamber with one or more additional valve members, including metering fluid flow from the control chamber with a pilot poppet. The method may also include controlling the position of at least one of the one or more additional valve members at least partially as a function of the position of the first valve member.

A further embodiment relates to a valve having a housing with a first port and a second port. The valve may also include a first valve member operable to meter fluid flow between the first port and the second port. Additionally, the valve may include valve controls operable to control the position of the first valve member at least partially with fluid supplied to a control chamber. The valve controls may include a first supply passage connected between the first port and the control chamber, the first supply passage including a first check valve that allows fluid flow from the first port to the control chamber. The valve controls may also include a second supply passage connected between the second port and the control chamber, the second supply passage including a second check valve that allows fluid flow from the second port to the control chamber. Additionally, the valve controls may include one or more drain passages connected to the control chamber. The valve controls may also include one or more additional valve members operable to meter fluid flow to the control chamber through the first supply passage and also fluid flow to the control chamber through the second supply passage.

### BRIEF DESCRIPTION OF THE DRAWINGS

FIG. 1 is a sectional view of one embodiment of a valve according to the present disclosure in a first operating state;

FIG. 2 is a sectional view of the valve shown in FIG. 1 in a second operating state; and

FIG. 3 is a sectional view of the valve shown in FIG. 1 in a third operating state.

### DETAILED DESCRIPTION

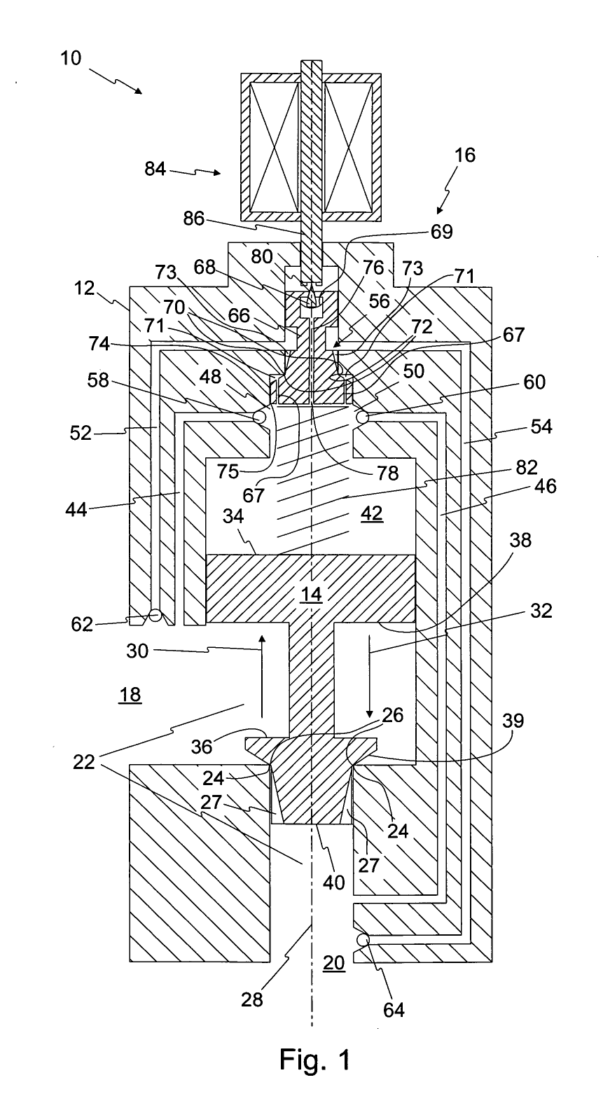

FIG. 1 illustrates one embodiment of a valve 10 according to the present disclosure. Valve 10 may include a housing 12, a valve member 14, and valve controls 16. Housing 12 may include a port 18, a port 20, and a passage 22 extending between port 18 and port 20. As shown in FIG. 1, housing 12 may also include various other features.

Valve member 14 may be configured to meter fluid flow through passage 22. As FIG. 1 shows, valve member 14 may be a poppet. Valve member 14 may include a valve seat 24 configured to sealingly abut a valve seat 26 of housing 12. Valve seat 24 may face generally in a direction 32, and valve seat 26 may face generally in an opposite direction 30. Valve member 14 may also include surfaces 34, 36 that face in direction 30. Additionally, valve member 14 may include a surface 38 that faces in direction 32. Furthermore, valve member 14 may include a surface 39 that extends around valve seat 24 and faces generally in direction 32. Additionally, valve member 14 may include a surface 40 that is circumscribed by valve seat 24 and faces generally in direction 32. Valve 10 may include provisions that constrain translation of valve member 14 to sliding along an axis 28 in directions 30, 32. For example, as FIG. 1 shows, surfaces of housing 12 extending parallel to axis 28 may guide surfaces of valve member 14 extending parallel to axis 28.

Various portions of valve member 14 may have various proportions with respect to one another. In some embodiments, surfaces 36, 38, 39, and 40 may collectively have a net area facing in direction 32 that is substantially equal to the area of surface 34 facing in direction 30. Additionally, in some embodiments, the area of surface 40 facing in direction 32 may be substantially equal to half of the area of surface 34 facing in direction 30. In such embodiments, surfaces 36, 38, 39 may have a net area facing in direction 32 that is substantially equal to the area of surface 40 facing in direction 32.

Valve member 14 may be configured in various manners that allow fluid flow between port 18 and port 20 when valve seat 24 is separated from valve seat 26. For example, in some embodiments, valve member 14 may include metering channels 27 through which fluid may flow.

Valve controls 16 may be configured to control the position of valve member 14 at least partially with fluid supplied to a control chamber 42. As FIG. 1 shows, in some embodiments, control chamber 42 may be defined by housing 12 adjacent one or more surfaces of valve member 14, such as surface 34. In addition to control chamber 42, valve controls 16 may include provisions for directing fluid to and from control chamber 42. For example, valve controls 16 may include supply passages 44, 46 and drain passages 52, 54. Each supply passage 44, 46 may be connected between a port 18, 20 and a port 48, 50 of control chamber 42. Supply passage 44 may include a check valve 58 operable to allow fluid flow from port 18, through port 48, to control chamber 42. Similarly, supply passage 46 may include a check valve 60 operable to allow fluid flow from port 20, through port 50, to control chamber 42. Each drain passage 52, 54 may be connected between a port 18, 20 and a port 56 of control chamber 42. Drain passage 52 may include a check valve 62 configured to allow fluid flow from port 56 to port 18, and drain passage 54 may include a check valve 64 operable to allow fluid flow from port 56 to port 20.

Valve controls 16 may also include one or more additional valve members operable to meter fluid flow to and/or from control chamber 42. For example, as FIG. 1 shows, valve controls 16 may include a pilot poppet 66 and a valve member 68. Pilot poppet 66 may have a valve seat 70 that is configured to sealingly abut a valve seat 72 associated with port 56. Valve 10 may include provisions for constraining translation of pilot poppet 66 to sliding along an axis, such as axis 28. As FIG. 1 shows, in some embodiments, surfaces of housing 12 that extend parallel to axis 28 may guide side surfaces of pilot poppet 66 that also extend parallel to axis 28.

Pilot poppet 66 may be configured in various ways that allow fluid flow between control chamber 42 and drain passages 52, 54 when valve seat 70 is separated from valve seat 72. For example, in some embodiments, pilot poppet 66 may include passages 67 extending from control chamber 42 to spaces 71 between pilot poppet 66 and housing 12, and pilot poppet 66 may include metering channels 73.

In some embodiments, pilot poppet 66 may include one or more side surfaces configured to meter fluid flow into or out of control chamber 42. For example, pilot poppet 66 may include a side surface 74 configured to meter fluid flow through ports 48, 50. As FIG. 1 shows, in some embodiments, side surface 74 may have an end 75 that may be moved across each port 48, 50. Alternatively, side surface 74 may include one or more openings (not shown) that may be moved across a port 48, 50.

Pilot poppet 66 may also include a passage 76 extending from an opening 78 to an opening 80. Opening 78 may be in direct fluid communication with control chamber 42. When valve seat 70 sealingly abuts valve seat 72, opening 80 may be connected to control chamber 42 only through passage 76. Valve member 68 may be configured to meter fluid flow through passage 76. Valve controls 16 may include a spring 69 that biases valve member 68 in direction 30 to cause valve member 68 to seal passage 76 as shown in FIG. 1.

Valve controls 16 may also include various provisions for moving pilot poppet 66 and valve member 68. For example, valve controls 16 may include an actuator 84 for driving pilot poppet 66 and valve member 68. Actuator 84 may be an electric solenoid having a plunger 86 configured to abut pilot poppet 66 and valve member 68. When activated, actuator 84 may drive plunger 86 in direction 32, thereby driving valve member 68 and pilot poppet 66 in direction 32. Plunger 86 may be configured to engage valve member 68 and drive it in direction 32 before engaging pilot poppet 66 and driving it in direction 32.

In some embodiments, valve controls 16 may be configured to control the position of pilot poppet 66 at least partially as a function of the position of valve member 14. For example, valve controls 16 may include a spring 82 compressed between valve member 14 and pilot poppet 66. Spring 82 may urge pilot poppet 66 in direction 30 against any force applied to pilot poppet 66 by actuator 84. Similarly, spring 82 may urge valve member 14 in direction 32.

Valve 10 is not limited to the configuration shown in FIG. 1. For example, the surfaces of valve member 14 may have different relative sizes than those described above. Additionally, valve member 14 may be a type of valve member other than a poppet, such as a spool. Furthermore, valve controls 16 may be configured differently than shown in FIG. 1. In some embodiments, rather than valve member 14 having surface 34 adjacent control chamber 42, valve controls 16 may include an additional drive member that has a surface adjacent control chamber 42 and is connected directly or indirectly to valve member 14. Additionally, one or more of supply passages 44, 46 and drain passages 52, 54 may extend through valve member 14, rather than through housing 12. Furthermore, valve controls 16 may omit supply passage 46 and drain passage 54, and/or include supply and drain passages not shown in FIG. 1.

Additionally, in some embodiments valve controls 16 may be configured to supply fluid to control chamber 42 through port 56 and drain fluid from control chamber 42 through ports 48, 50, rather than supplying fluid to control chamber 42 through ports 48, 50 and draining fluid from control chamber 42 through port 56. Valve controls 16 may include various configurations for doing so. For example, supply passages 44, 46 may extend from ports 18, 20 to port 56, rather than extending to ports 48, 50, and drain passages 52, 54 may extend from ports 48, 50 to ports 18, 20, rather than extending from port 56.

Valve controls 16 may also have different arrangements of valve members for metering fluid flow to and from control chamber 42. For example, valve controls 16 may include multiple valve members for metering fluid flow into and out of control chamber 42, in place of pilot poppet 66.

Valve controls 16 may also include different provisions for controlling the position of pilot poppet 66. For example, actuator 84 may be a type of actuator other than an electric solenoid, such as a hydraulic or pneumatic actuator. Additionally, valve controls 16 may include provisions other than spring 82 for controlling the position of pilot poppet 66 at least partially as a function of the position of valve member 14. Valve controls 16 may include a different type of force transfer mechanism connected between pilot poppet 66 and valve member 14. Additionally, in some embodiments, valve controls 16 may include a position sensor that senses the position of valve member 14 and information-processing components for controlling actuator 84 at least partially as a function of the output signal of the position sensor.

### INDUSTRIAL APPLICABILITY

Valve 10 may have application wherever control of fluid flow is required. Each port 18, 20 of housing 12 may be connected to one or more components configured to supply fluid to and/or receive fluid from valve 10, including, but not limited to, pumps, valves, fluid-driven actuators, and reservoirs.

When actuator 84 is not activated, valve 10 may have the operating state shown in FIG. 1, wherein valve member 14 may substantially prevent fluid flow between ports 18, 20. With actuator 84 not applying force to pilot poppet 66 or valve member 68, spring 82 may hold valve seat 70 of pilot poppet 66 against valve seat 72, and valve member 68 may seal passage 76. This prevents fluid communication between control chamber 42 and drain passages 52, 54.

Under such circumstances, one of supply passages 44, 46 will be in fluid communication with control chamber 42. If the fluid pressure at port 18 is higher than the fluid pressure at port 20, check valve 58 will allow fluid communication from port 18 to control chamber 42 while check valve 60 prevents fluid communication from control chamber 42 to port 20. If the fluid pressure at port 20 is higher than the fluid pressure at port 18, check valves 58, 60 may allow fluid communication from port 20 to control chamber 42 while preventing fluid communication from control chamber 42 to port 18. This ensures that the pressure of fluid in control chamber 42 is substantially equal to the higher of the fluid pressures at ports 18, 20. As a result, in combination with spring 82 pressing against surface 34, the fluid in control chamber 42 pressing against surface 34 holds valve seat 24 of valve member 14 against valve seat 26, thereby substantially preventing fluid communication between ports 18, 20.

When valve 10 is in the state shown in FIG. 1, fluid in contact with various surfaces of pilot poppet 66 may apply unbalanced force to pilot poppet 66, urging valve seat 70 against valve seat 72. The high-pressure fluid in control chamber 42 may apply higher force on pilot poppet 66 in direction 30 than fluid in other portions of housing 12 applies to pilot poppet 66 in direction 32. In some circumstances, the unbalanced fluid force acting on pilot poppet 66 may be greater than the force capacity of actuator 84.

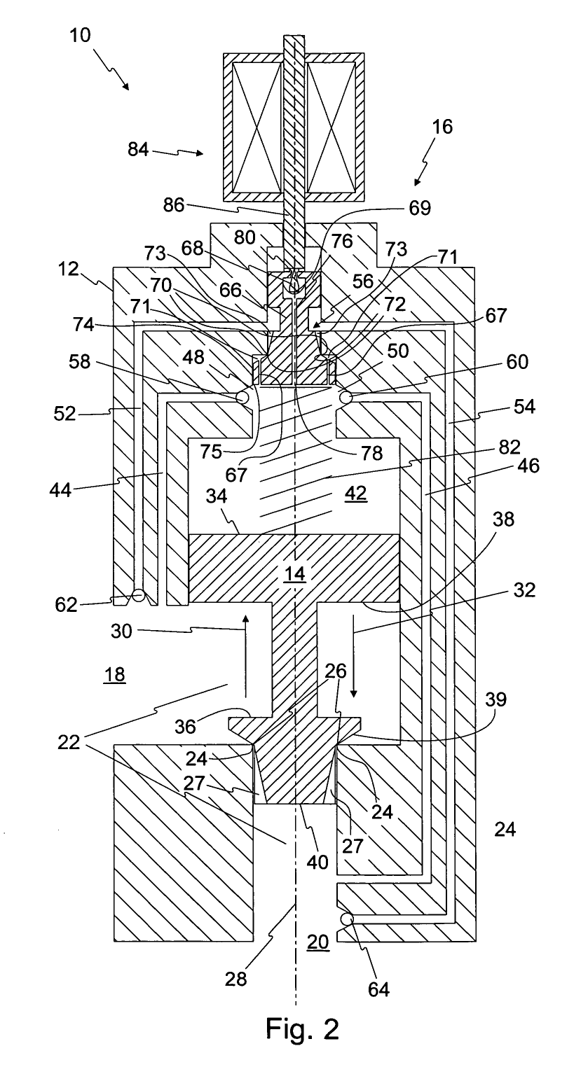

Because plunger 86 is configured to engage valve member 68 before engaging pilot poppet 66, as actuator 84 drives plunger 86 in direction 32, the fluid forces on pilot poppet 66 may balance before plunger 86 engages pilot poppet 66. As FIG. 2 shows, when plunger 86 engages valve member 68 and drives it in direction 32, valve member 68 may allow fluid communication through passage 76. This may allow the high fluid pressure in control chamber 42 to communicate through passage 76 to the end of pilot poppet 66 opposite control chamber 42, thereby substantially balancing the fluid force on pilot poppet 66.

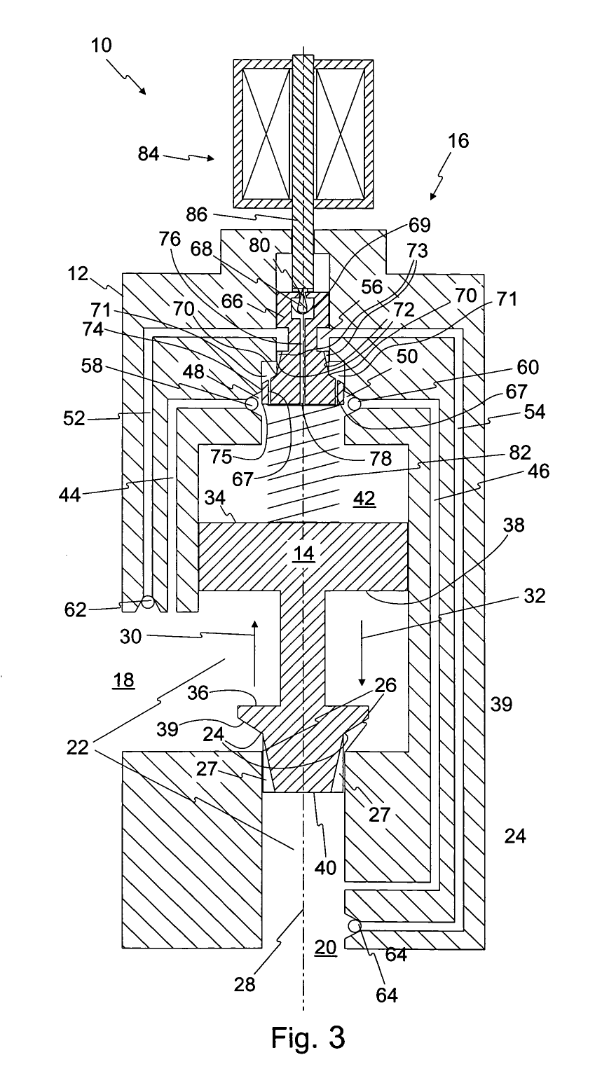

With the fluid force on pilot poppet 66 substantially balanced, actuator 84 may readily drive pilot poppet 66 in direction 32. As is shown in FIG. 3, this may separate valve seat 70 from valve seat 72. With valve seat 70 separated from valve seat 72, fluid may flow from control chamber 42, through passages 67, through spaces 71, through metering channels 73, and through port 56, to drain passages 52, 54. Additionally, moving pilot poppet 66 in direction 32 may cause side surface 74 to at least partially block ports 48, 50. As a result, side surface 74 of pilot poppet 66 may resist fluid flow into control chamber 42 through port 48 or port 50.

The resistance that pilot poppet 66 presents to fluid flow into control chamber 42 and the resistance that pilot poppet 66 presents to fluid flow out of control chamber 42 may both vary with the position of pilot poppet 66 along axis 28. As actuator 84 drives pilot poppet 66 in direction 32, the distance between valve seats 70, 72 may increase, and side surface 74 may block ports 48, 50 to an increasing extent. Thus, as actuator 84 drives pilot poppet 66 in direction 32, pilot poppet 66 presents decreasing resistance to fluid flow out of control chamber 42 through port 56 and increasing resistance to fluid flow into control chamber 42 through ports 48, 50. Conversely, if pilot poppet 66 moves in direction 30, pilot poppet 66 presents increasing resistance to fluid flow out of control chamber 42 through port 56 and decreasing resistance to fluid flow into control chamber 42 through ports 48, 50.

As a result, driving pilot poppet 66 in direction 32 may cause valve member 14 to move in direction 30. As the resistance to flow through port 56 decreases, high-pressure fluid may flow from control chamber 42, through one of drain passages 52, 54, to whichever port 18, 20 has lower fluid pressure. This may reduce the pressure in control chamber 42. Restricting fluid flow through ports 48, 50 may further reduce pressure in control chamber 42 by reducing the rate at which fluid flows into control chamber 42 to replace the fluid flowing out. As the pressure in control chamber 42 decreases, the force of fluid acting on valve seat 24, surface 38, and surface 40 may eventually overcome the force of fluid in control chamber 42 and drive valve member 14 in direction 30, separating valve seat 24 from valve seat 26 and allowing flow between ports 18, 20.

When valve seat 24 is separated from valve seat 26, variations in fluid pressure at ports 18, 20 may have a tendency to create undesirable movement of valve member 14. Valve controls 16 may dampen such undesirable movement of valve member 14 by controlling the position of pilot poppet 66 at least partially as a function of the position of valve member 14. If a pressure fluctuation at ports 18, 20 causes valve member 14 to move in direction 30, spring 82 may drive pilot poppet 66 in direction 30, causing an increase in pressure in control chamber 42 to drive valve member 14 back in direction 32. Conversely, if a pressure fluctuation at ports 18, 20 causes valve member 14 to move in direction 32, spring 82 may allow pilot poppet 66 to move in direction 32, causing a decrease in pressure in control chamber 42 to allow pressure in ports 18, 20 to drive valve member 14 back in direction 30.

Valve 10 may be returned to the operating state shown in FIG. 1 by discontinuing application of force to pilot poppet 66 by actuator 84. With actuator 84 applying no force to pilot poppet 66, spring 82 may drive pilot poppet 66 in direction 30 until valve seat 70 abuts valve seat 72 and side surface 74 exposes ports 48, 50. As a result, the pressure in control chamber 42 may rise and drive valve member 14 in direction 32 until valve seat 24 abuts valve seat 26.

The disclosed embodiments may provide a number of performance advantages. Because they are operable to simultaneously increase drainage of fluid from control chamber 42 and decrease supply of fluid to control chamber 42, the disclosed valve controls 16 may be capable of causing valve member 14 to move rapidly in direction 30. Conversely, by simultaneously decreasing drainage of fluid from control chamber 42 and increasing supply of fluid to control chamber 42, valve controls 16 may cause valve member 14 to move rapidly in direction 32.

Additionally, the disclosed embodiments of valve 10 may experience minimal leakage when closed. Valve seats 24, 26 may provide a very tight seal, preventing fluid flow between ports 18, 20 through passage 22. Similarly, valve seats 70, 72 and valve member 68 may prevent a very tight seal, preventing fluid from leaking out of control chamber 42.

Furthermore, including both supply passage 44 and supply passage 46 may allow bidirectional operation of valve 10. As is discussed above, supply passages 44, 46 may allow fluid flow to control chamber 42 from whichever port 18, 20 is at higher pressure. This may allow valve controls 16 to exercise control over the position of valve member 14 regardless of which port 18, 20 has higher fluid pressure. As a result, valve 10 may be used in applications where the pressure in port 18 may be sometimes higher and sometimes lower than the pressure in port 20.

It will be apparent to those skilled in the art that various modifications and variations can be made in the valve and methods without departing from the scope of the disclosure. Other embodiments of the disclosed valve and methods will be apparent to those skilled in the art from consideration of the specification and practice of the valve and methods disclosed herein. It is intended that the specification and examples be considered as exemplary only, with a true scope of the disclosure being indicated by the following claims and their equivalents.

What is claimed is:

1. A valve, comprising:
a housing having a first port and a second port;
a first valve member operable to meter fluid flow between the first port and the second port;
valve controls operable to control the position of the first valve member at least partially with fluid supplied to a control chamber, the valve controls including
one or more additional valve members operable to meter fluid flow to the control chamber and also fluid flow from the control chamber, the one or more additional valve members including a pilot poppet operable to meter fluid flow from the control chamber, and
wherein the valve controls are operable to control the position of at least one of the one or more additional valve members at least partially as a function of the position of the first valve member.

2. The valve of claim 1, wherein the pilot poppet is also operable to meter fluid flow into the control chamber.

3. The valve of claim 2, wherein the valve controls are operable to control the position of the pilot poppet at least partially as a function of the position of the first valve member.

4. The valve of claim 2, wherein the pilot poppet is operable to
decrease resistance to fluid flow out of the control chamber and increase resistance to fluid flow into the control chamber when the pilot poppet is moving in a first direction, and
increase resistance to fluid flow out of the control chamber and decrease resistance to fluid flow into the control chamber when the pilot poppet is moving in a second direction.

5. The valve of claim 1, wherein:
the control chamber includes a third port and a fourth port;
the pilot poppet is moveable along an axis;
the pilot poppet includes a first valve seat operable to abut a second valve seat associated with the third port;
the valve controls are operable to adjust resistance to fluid flow through the third port by adjusting the position of the poppet along the axis to adjust the distance between the first valve seat and the second valve seat; and
in at least one position of the pilot poppet along the axis, a side surface of the pilot poppet at least partially blocks the fourth port, the extent to which the side surface blocks the fourth port being a function of the position of the pilot poppet along the axis.

6. The valve of claim 5, wherein the first valve member is a poppet having a third valve seat operable to abut a fourth valve seat associated with a passage between the first port and the second port.

7. The valve of claim 1, wherein:
the valve controls include
a first supply passage connected between the first port and the control chamber, the first supply passage including a check valve allowing fluid flow from the first port to the control chamber, and
a second supply passage connected between the second port and the control chamber, the second supply passage including a check valve allowing fluid flow from the second port to the control chamber;
the one or more additional valve members are operable to meter fluid flow into the control chamber through the first supply passage; and
the one or more additional valve members are operable to meter fluid flow into the control chamber through the second supply passage.

8. A method of operating a valve having a housing with a first port and a second port, the method including:
metering fluid flow between the first port and the second port at least partially by controlling the position of a first valve member;
wherein controlling the position of the first valve member includes metering fluid flow to a control chamber and fluid flow from the control chamber with one or more additional valve members, including metering fluid flow from the control chamber with a pilot poppet; and
controlling the position of at least one of the one or more additional valve members at least partially as a function of the position of the first valve member.

9. The method of claim 8, wherein metering fluid flow to the control chamber and fluid flow from the control chamber with one or more additional valve members includes metering fluid flow to the control chamber with the pilot poppet, in addition to metering fluid flow from the control chamber with the pilot poppet.

10. The method of claim 9, wherein metering fluid flow from the control chamber and fluid flow to the control chamber with the pilot poppet includes
decreasing restriction from the pilot poppet to fluid flow out of the control chamber while increasing restriction from the pilot poppet to fluid flow into the control chamber by moving the pilot poppet in a first direction, and
increasing restriction from the pilot poppet to fluid flow out of the control chamber while decreasing restriction from the pilot poppet to fluid flow into the control chamber by moving the pilot poppet in a second direction.

11. The method of claim 9, wherein metering fluid flow from the control chamber and fluid flow to the control chamber with the pilot poppet includes adjusting the position of the pilot poppet along an axis, thereby adjusting a distance between a valve seat of the pilot poppet and a valve seat associated with a first port of the control chamber, and also an extent to which a side surface of the pilot poppet blocks a second port of the control chamber.

12. The method of claim 8, wherein controlling the position of at least one of the one or more additional valve members at least partially as a function of the position of the first valve member includes controlling the position of the pilot poppet at least partially as a function of the position of the first valve member.

13. The method of claim 8, wherein metering fluid flow to the control chamber with the one or more additional valve members includes metering fluid flow from the first port to the control chamber in at least some circumstances.

14. The method of claim 13, wherein metering fluid flow to the control chamber with the one or more additional valve members further includes metering fluid flow from the second port to the control chamber in at least some circumstances.

15. A valve, comprising:
a housing having a first port and a second port;
a first valve member operable to meter fluid flow between the first port and the second port;
valve controls operable to control the position of the first valve member at least partially with fluid supplied to a control chamber, the valve controls including
a first supply passage connected between the first port and the control chamber, the first supply passage including a first check valve that allows fluid flow from the first port to the control chamber,
a second supply passage connected between the second port and the control chamber, the second supply passage including a second check valve that allows fluid flow from the second port to the control chamber,
one or more drain passages connected to the control chamber, and
one or more additional valve members operable to meter fluid flow to the control chamber through the first supply passage and also fluid flow to the control chamber through the second supply passage.

16. The valve of claim 15, wherein the one or more additional valve members are also operable to meter fluid flow out of the control chamber through the one or more drain passages.

17. The valve of claim 16, wherein the one or more additional valve members include one valve member that is operable to
meter fluid flow into the control chamber from at least one of the first supply passage and the second supply passage, and
meter fluid flow out of the control chamber through at least one of the one or more drain passages.

18. The valve of claim 16, wherein the valve controls are operable to control the position of at least one of the additional valve members at least partially as a function of the position of the first valve member.

19. The valve of claim 16, wherein the one or more additional valve members include a pilot poppet operable to meter fluid flow out of the control chamber.

20. The valve of claim 16, wherein the valve controls are operable to, in at least some circumstances, actuate the one or more additional valve members to decrease resistance to fluid flow out of the control chamber while increasing the resistance to fluid flow into the control chamber.
